(19) United States
(12) Patent Application Publication
(10) Pub. No.: US 2004/0246571 A1
(43) Pub. Date: Dec. 9, 2004

(54) MAGNETIC TOOL HOLDER

(76) Inventor: Russell Bonaventura, Williamsville, NY (US)

Correspondence Address: SIMPSON & SIMPSON, PLLC, 5555 MAIN STREET, WILLIAMSVILLE, NY, 14221-5406, US

(21) Appl. No.: 10/250,115

(22) Filed: Jun. 4, 2003

(51) Int. Cl. G02B 21/00

(52) U.S. Cl. 359/368; 359/390; 359/656; 359/821

(57) ABSTRACT

A novel apparatus for storing a microscope tool is presented. A magnetic tool holder comprises a block or other device having at least one borehole having a magnet attached to the bottom of the borehole. A block is defined as a article or item having sufficient mass to maintain stability when at least one borehole is formed in it. The apparatus may further comprise an insert configured to line the wall or walls of the borehole. A microscope assembly is also shown having at least one borehole formed into the microscope and including a magnet attached to the bottom of the borehole. Also shown is in combination, a magnetic tool holder and a microscope objective tool comprising a block having at least one borehole, a magnet securely attached to the bottom of the borehole and at least one microscope objective tool fabricated at least partly from ferromagnetic material.

### FIELD OF THE INVENTION

The present invention relates generally to microscopy, more specifically to microscopes, and, even more particularly to microscope tool holders.

### BACKGROUND

As is well known, a microscope is an optical instrument used to view, examine and study very small objects. There are many different types of microscopes, each best suited to particular applications. These include compound microscopes, stereomicroscopes, confocal microscopes, inverted microscopes, laser microscopes, fluorescence microscopes and polarizing microscopes, to name but a few.

The present invention relates generally to compound microscopes and to those microscopes which use the same or similar optical arrangement found in a compound microscope such as a polarizing microscope.

A variety of tools are often used with microscopes to repair components, replace light filters, and to add or remove components. Adjusting tools are often used with microscopes, to align or adjust microscope objectives and, in polarizing microscopes, to align or adjust Bertrand lens. In addition, different ancillary components are often available to be used with certain microscopes. These include, but are not limited to, light filters, phase contrast ring inserts and diverse microscope eyepieces and objectives. One frequent difficulty in working with such tools or other components is the number of such items that are available for use with microscopes. This is especially true in a laboratory or product development setting in which the user's work space is often crowded with several instruments as well as unattached tools, components and other items all of which tend to create a cluttered environment, often in a short period of time. In such situations, tools and other pieces of equipment, especially those small in size, are easily misplaced or even permanently lost.

One such device is the tool used to adjust microscope objectives and the Bertrand lens used in polarizing microscopes. These tools are normally small, comprising a small shaft with a small flat end attached to a small knob-like handle. In a crowded, cluttered work environment, the tool can be readily lost or the small adjusting end can be easily damaged or broken.

What is needed then is an apparatus for safely storing the adjusting tool so as prevent the tool from either being lost or damaged.

### SUMMARY OF THE INVENTION

The present invention broadly comprises a microscope assembly comprising a microscope having a section defining at least one borehole, with a magnet attached to the bottom of each borehole and, preferably, an insert lining the walls of each borehole and at least one microscope objective tool fabricated from ferromagnetic material.

The invention also comprises a magnetic tool holder broadly comprising a block, at least one borehole defined by the block, a magnet secured to the bottom of each borehole and, preferably, an insert lining the walls of each borehole.

The invention also broadly comprises, in combination, a magnetic tool holder and a microscope objective tool having a block, at least one borehole defined by the block, a magnet securely attached to the bottom of the at least one borehole, and least one microscope objective tool, where the at least one microscope objective tool is fabricated at least partly from ferromagnetic material. Preferably, the combination also includes an insert lining the walls of each of the boreholes.

A general object of the invention is to provide a convenient storage location for the microscope adjusting tools.

A second object of the invention is to provide a storage location for the microscope adjusting tools on the body of the microscope without creating interference with the operation of the microscope.

An additional object of the invention is to provide a storage system that prevents loss of the microscope adjusting tool when the microscope is tipped or placed in placed in an unwieldy angle.

### BRIEF DESCRIPTION OF THE SEVERAL VIEWS OF THE DRAWINGS

The nature and mode of operation of the present invention will now be more fully described in the following detailed description of the invention taken with the accompanying drawing figures, in which:

FIG. 1 is a rear view of a typical microscope with which the magnetic tool holder of the present invention is adaptable for use;

FIG. 2 is a side perspective view of a tool used to adjust the objectives and Bertrand lens of a microscope;

FIG. 3 is a side view of magnetic tool holder of the present invention showing two boreholes with countersinks;

FIG. 4 is an exploded side perspective view of an embodiment of the combination of the magnetic tool holder of the present invention and a microscope objective tool;

FIG. 5 is a cross section view of the magnetic tool holder of the present invention and a microscope objective tool located within a borehole of the magnetic tool holder; and,

FIG. 6 is a side view of a typical microscope, in which the microscope is tilted at an angle.

### DETAILED DESCRIPTION OF THE INVENTION

At the outset, it should be appreciated that like drawing numbers on different drawing views identify identical structural elements of the invention. While the present invention is described with respect to what is presently considered to be the preferred embodiments, it is understood that the invention is not limited to the disclosed embodiments.

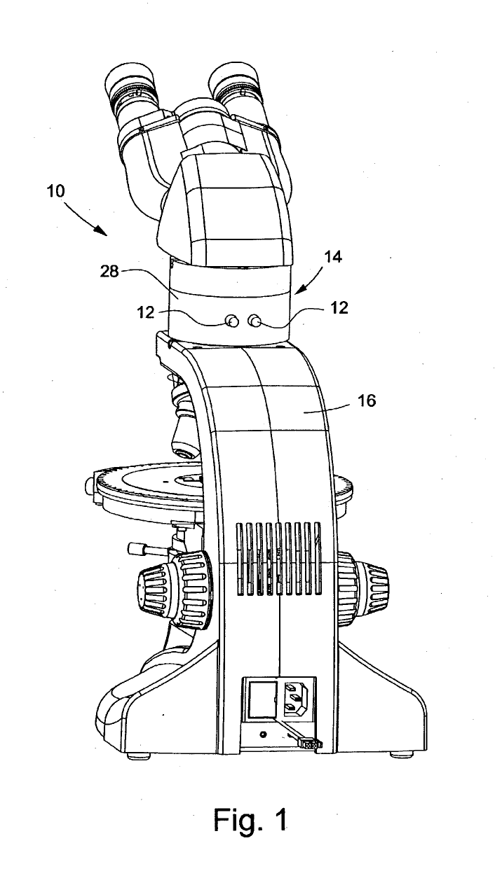

The present invention broadly comprises a microscope assembly including a microscope having objectives, a Bertrand lens, and tools used to adjust and align the microscope objectives and Bertrand lens. FIG. 1 illustrates a rear view of compound microscope 10. Arm 16 of microscope 10 supports incident light illuminator 14. FIG. 1 also depicts microscope tools (tools) 12 held in position in the outer rear wall of incident light illuminator housing 14.

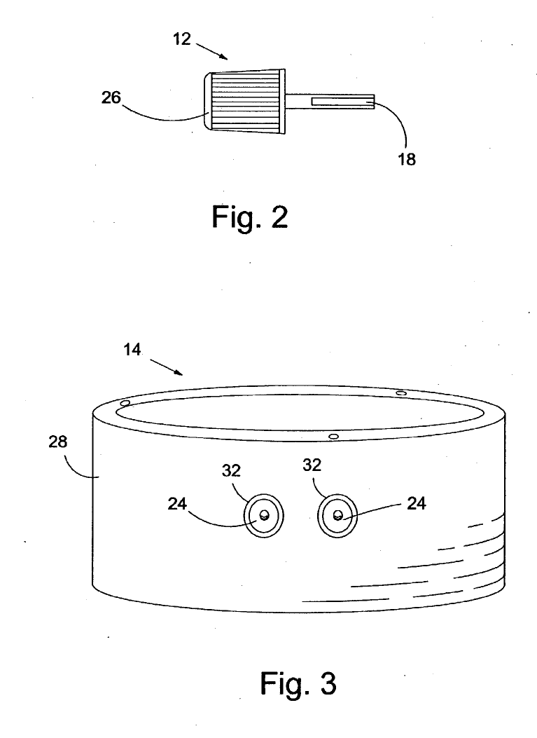

FIG. 2 is a side view of tool 12 showing adjusting tip 18 and handle 26 which is used to align the objectives of microscope 10 as well as the Bertrand lens (not shown) of a polarizing microscope. Adjusting tip 18 is formed at least partly from ferromagnetic material that is attracted to magnets. FIG. 3 shows housing 14 separate from microscope 10 and containing boreholes 24. In an alternative embodiment, a separate block or other device, not integrated with microscope 10, may contain boreholes 24.

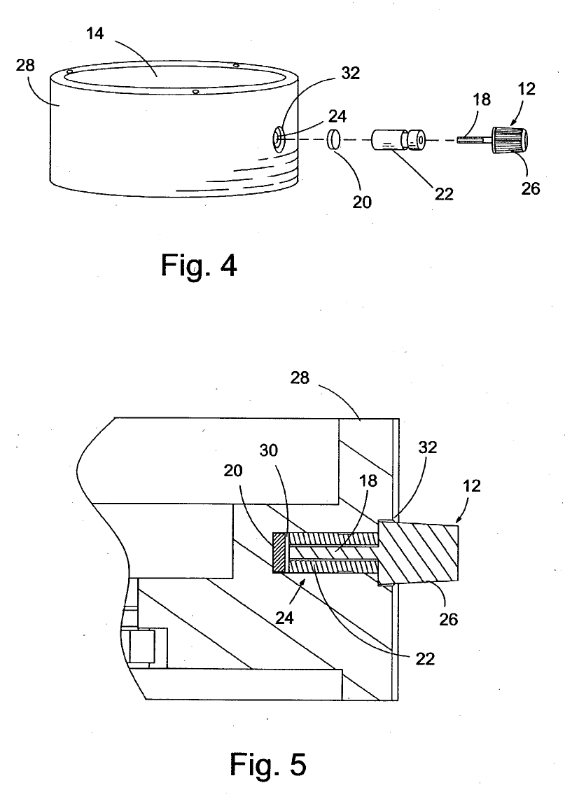

FIG. 4 is an exploded side perspective view depicting a preferred embodiment of the magnetic tool holder of the present invention. Borehole 24 is shown formed in outer wall 28 of housing 14. Magnet 20 is sized to fit in the bottom of borehole 24. Magnet 20 may be affixed to the bottom of borehole 24 using appropriate adhesives capable of forming secure metal-to-metal or other appropriate connections. Such adhesives are well known to those skilled in the art. In a preferred embodiment, insert 22 is placed into borehole 24 and is sized to line the walls of borehole 24. In a more preferred embodiment, insert 22 is fabricated from aluminum, plastic or other nonferromagnetic material. Nonferromagnetic material is defined as material that is not influenced by magnetic force or attracted to magnetic material. In an alternative embodiment, magnet 20 and insert 22 may be formed into an integral unit. Use of insert 22 enables a fabricator to drill a borehole with a diameter sufficient to avoid drill bit breakage. Drill bit breakage may tend to occur at an increased level if the diameter of borehole 24 is too small relative to the depth of borehole 24. Use of insert 22 allows the fabricator to safely drill borehole 24 and then decrease its operational diameter to allow a snug fit for tool 12. Tool 12 is then placed into insert 22. In a more preferred embodiment, counter sink 32 is located at the outer end of borehole 24. Counter sink 32 is sized to receive a portion of handle 26, allowing that portion of handle 26 to fit below the surface of outer wall 28.

FIG. 5 is a cross section view of the magnetic tool holder of the present invention. Tool 12 is inserted into borehole 24 lined with insert 22. In a preferred embodiment, adjusting tip 18 is sized to be shorter than the length of borehole 24 when magnet 20 is placed at the closed end of borehole 24. This shorter length of adjusting tip 18 creates gap 30 when tool 12 is placed into borehole 24. This allows a snug fit of tool 12 in borehole 24 and ensures that handle 26 will be held firmly against the outer surface of wall 28 or, in a preferred embodiment, firmly against countersink 32.

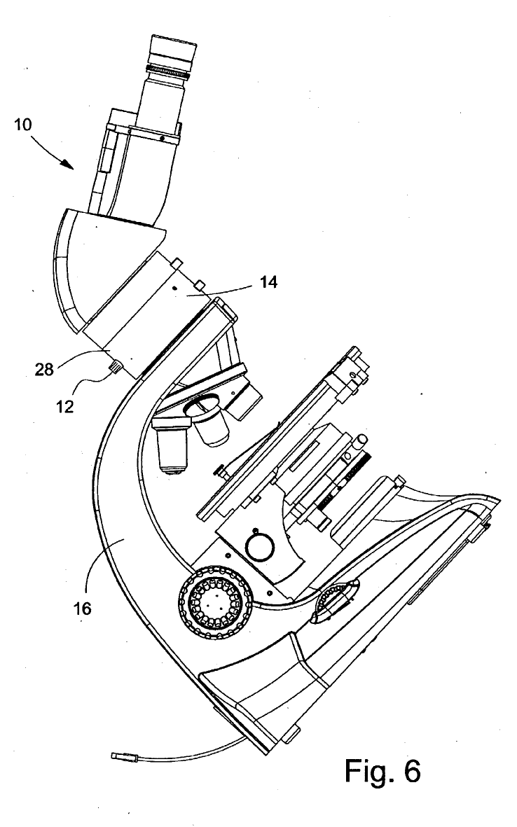

FIG. 6 depicts a side view of microscope 10 incorporating the magnetic tool holder of the present invention. Microscope 10 is shown tipped at an angle. Tool 12 is shown held against wall 28 of housing 14 even though microscope 10 is angled such that tool 12 would normally fall away from wall 28. FIG. 6 demonstrates the advantage of the magnetic tool holder of the present invention in reducing the possibility of tool 12 being lost or separated from microscope 10.

Thus it is seen that the objects of the invention are efficiently obtained, although changes and modifications to the invention should be readily apparent to those having ordinary skill in the art, which changes are considered to be within the scope of the invention as claimed. For example, as explained above, an alternative embodiment of the present invention, a block or other similar article separate from microscope 10 may be fabricated in a similar manner having boreholes with suitable magnets that may be used to hold microscope tools.

1. A magnetic tool holder comprising:
a block;
at least one borehole defined by said block; and,
a magnet securely attached to the bottom of each of said at least one borehole.

2. The magnetic tool holder recited in claim 1 further comprising an insert lining the wall of each of said at least one borehole.

3. The magnetic tool holder as recited in claim 2 wherein said insert is fabricated from plastic.

4. The magnetic too holder as recited in claim 2 wherein said insert is fabricated from nonferromagnetic metal.

5. The magnetic tool holder as recited in claim 4 wherein in said nonferromagnetic insert is fabricated from aluminum.

6. The magnetic tool holder as recited in claim 2 wherein said magnet and said insert are an integral unit.

7. The magnetic tool holder as recited in claim 1 wherein said at least one borehole has a countersink

8. A microscope assembly, comprising:
a microscope;
at least one borehole formed into said microscope; and,
a magnet securely attached to the bottom of each of said at least one borehole.

9. The microscope assembly recited in claim 8 further comprising an insert lining the wall of each of said at least one borehole.

10. The microscope assembly recited in claim 9 wherein said insert is fabricated from plastic.

11. The microscope assembly recited in claim 9 wherein said insert is fabricated from nonferromagnetic metal.

12. The microscope assembly recited in claim 11 wherein said nonferromagnetic insert is fabricated from aluminum.

13. The microscope assembly recited in claim 9 wherein said magnet and said insert are an integral unit.

14. The microscope assembly recited in claim 8 wherein said at least one borehole has a countersink.

15. The microscope assembly recited in claim 8 further comprising a microscope objective tool.

16. In combination, a magnetic tool holder and a microscope objective tool comprising:
a block, said block having at least one borehole defined by said block;
a magnet securely attached to the bottom of said at least one borehole; and,
at least one microscope objective tool, wherein said at least one microscope objective tool is fabricated at least partly from ferromagnetic material.

17. The combination of magnetic tool holder and microscope objective tool recited in claim 16 further comprising an insert lining the wall of each of said at least one borehole.

18. The combination of magnetic tool holder and microscope objective tool recited in claim 17 wherein said insert is fabricated from plastic.

19. The combination of magnetic tool holder and microscope objective tool recited in claim 17 wherein said insert is fabricated from nonferromagnetic metal.

20. The combination of magnetic tool holder and microscope objective tool recited in claim 19 wherein said nonferromagnetic insert is fabricated from aluminum.

21. The combination of magnetic tool holder and microscope objective tool recited in claim 17 wherein said magnet and said insert are an integral unit.

22. The combination of magnetic tool holder and microscope objective tool recited in claim 16 wherein said at least one borehole has a countersink.
